(19) United States
(12) Patent Application Publication
(10) Pub. No.: US 2015/0183433 A1
(43) Pub. Date: Jul. 2, 2015

(54) VEHICLE CONTROL DEVICE AND VEHICLE CONTROL METHOD

(71) Applicant: FUJI JUKOGYO KABUSHIKI KAISHA, Tokyo (JP)

(72) Inventor: Hiroyuki SUZUKI, Tokyo (JP)

(73) Assignee: FUJI JUKOGYO KABUSHIKI KAISHA, Tokyo (JP)

(21) Appl. No.: 14/577,005

(22) Filed: Dec. 19, 2014

(30) Foreign Application Priority Data
Dec. 26, 2013 (JP) 2013-268734

(51) Int. Cl. B60W 30/16

(52) U.S. Cl. CPC B60W 30/16

(57) ABSTRACT

A vehicle control device is capable of executing follow-up control having a follow-up mode based on inter-vehicle distance in which cruise control is performed based on a target inter-vehicle distance and a follow-up mode based on vehicle speed in which cruise control is performed based on a target vehicle speed. The vehicle control device includes a forward monitoring unit that monitors information in the advancing direction of a vehicle equipped with the vehicle control device, and a follow-up control unit that eases the follow-up in the follow-up control and executes a deceleration operation of the vehicle when at least either one of a situation in which a preceding vehicle is predicted to decelerate and execution of a braking operation of the preceding vehicle is detected based on the information in the advancing direction.

### CROSS-REFERENCE TO RELATED APPLICATIONS

The present application claims priority from Japanese Patent Application No. 2013-268734 filed on Dec. 26, 2013, the entire contents of which are hereby incorporated by reference.

### BACKGROUND

1. Technical Field

The present disclosure relates to a vehicle control device and a vehicle control method capable of executing follow-up control by a follow-up mode on the basis of an inter-vehicle distance and a follow-up mode on the basis of a vehicle speed.

2. Related Art

Vehicle control devices are previously known that, when a preceding vehicle has been detected ahead of a vehicle equipped with such device (subject vehicle), are capable of executing follow-up control with respect to the preceding vehicle which has been detected. This follow-up control has been put to practical use as Adaptive Cruise Control (ACC). In the state of a preceding vehicle having been detected ahead of the subject vehicle, this ACC executes follow-up control based on inter-vehicle distance on the basis of the inter-vehicle distance, while in the state of a preceding vehicle not having been detected, it executes follow-up control based on vehicle speed on the basis of a target vehicle speed that the driver has set.

During the execution of such follow-up control, when there exists a stop signal of a traffic light or obstacle on the travel route, it is of course not possible to continue with the follow-up control. Therefore, Japanese Patent No. 3646605 discloses a technology that predicts the state of the traffic light and, depending on the predicted state of the traffic light, changes the cruise control contents of the subject vehicle in order to enable execution of follow-up control even on a road with traffic lights.

However, in the control method disclosed in Japanese Patent No. 3646605, during execution of follow-up control, the follow-up control is interrupted and the subject vehicle stops when the state of a traffic light is predicted to be green or yellow when a preceding vehicle passes it, but the state of the traffic light is predicted to be yellow or red when the subject vehicle passes it. In other words, the control method disclosed in Japanese Patent No. 3646605 predicts a state in which the subject vehicle must not be allowed to pass through an intersection even if the preceding vehicle is able to pass, and stops the subject vehicle. Accordingly, the follow-up control is continued when the preceding vehicle stops at a red light.

Here, when follow-up control based on vehicle speed is executed in a situation of deceleration of the preceding vehicle being predicted, such as when a traffic light up ahead is a red light or a yellow light, or there being an obstacle ahead, the driver's foot has left the accelerator pedal and brake pedal, and thus a braking operation by the driver is delayed. Further, when follow-up control based on vehicle speed is continued in such circumstances, the subject vehicle decelerates after having accelerated until catching up with the preceding vehicle. Also, when follow-up control based on inter-vehicle distance is executed in the situation of deceleration of the preceding vehicle being predicted, the subject vehicle does not decelerate until the preceding vehicle decelerates. Under such circumstances, the subject vehicle suddenly decelerates, and so, compared to the case of gently decelerating, drivability suffers. Also, under such circumstances, a delay in the timing of the deceleration could lead to a worsening of fuel efficiency.

### SUMMARY OF THE INVENTION

The present disclosure was achieved in view of the above problems, and an object of the present disclosure is to provide a vehicle control device and a vehicle control method that, by predicting a situation in which a preceding vehicle decelerates, avoids sudden deceleration of the subject vehicle, and thereby improves drivability and fuel efficiency.

An aspect of the present disclosure provides a vehicle control device capable of executing follow-up control having a follow-up mode based on inter-vehicle distance in which cruise control is performed based on a target inter-vehicle distance and a follow-up mode based on vehicle speed in which cruise control is performed based on a target vehicle speed. The vehicle control device includes: a forward monitoring unit that monitors information in the advancing direction of a vehicle equipped with the vehicle control device, and a follow-up control unit that eases the follow-up in the follow-up control and executes a deceleration operation of the vehicle when at least either one of a situation in which a preceding vehicle is predicted to decelerate and execution of a braking operation of the preceding vehicle is detected based on the information in the advancing direction.

In the case of the vehicle being provided with an internal combustion engine as a drive source, the follow-up control unit may execute the deceleration operation by restricting the amount of fuel injection to the internal combustion engine.

In the case of the vehicle being provided with an electric motor capable of executing regenerative braking control as a drive source, the follow-up control unit may execute the deceleration operation by executing the regenerative braking control.

The follow-up control unit may execute the deceleration operation by increasing a gear ratio of a transmission interposed between a drive source and a drive shaft.

The follow-up control unit may execute the deceleration operation when the distance from the vehicle to the location of a cause of the situation in which the preceding vehicle is predicted to decelerate is equal to or greater than a predetermined value.

The follow-up control unit may, in the follow-up mode based on vehicle speed, release or change the current set value of the target vehicle speed when the situation in which the preceding vehicle is predicted to decelerate is not detected, and the execution of a braking operation of the preceding vehicle is detected.

The follow-up control unit may, in the follow-up mode based on vehicle speed, release or change the current set value of the target vehicle speed when the situation in which the preceding vehicle is predicted to decelerate is detected, irrespective of the execution of a braking operation of the preceding vehicle.

In the follow-up mode based on vehicle speed, the degree of easing of the follow-up in the case of a braking operation of the preceding vehicle being executed may be greater than the degree of easing of the follow-up in the case of a braking operation of the preceding vehicle not being executed.

In the case of the vehicle being provided with an internal combustion engine and an electric motor capable of executing regenerative braking control as a drive source, and in the case of the situation in which the preceding vehicle is predicted to decelerate being detected and the execution of a braking operation of the preceding vehicle being detected in the follow-up mode based on vehicle speed, the follow-up control unit may restrict the amount of fuel injection to the internal combustion engine and execute regenerative braking control, change the set value of the target vehicle speed and determine a target deceleration based on the changed set value of the target vehicle speed and the actual vehicle speed of the vehicle, and increase the regenerative amount of the regenerative braking control in the case of the target deceleration being predicted to be unachievable only by restriction of the amount of fuel injection.

In the case of the vehicle being provided with an internal combustion engine as a drive source, and in the case of the situation in which the preceding vehicle is predicted to decelerate being detected and the execution of a braking operation of the preceding vehicle being detected in the follow-up mode based on vehicle speed, the follow-up control unit may restrict the amount of fuel injection to the internal combustion engine, change the set value of the target vehicle speed and determine a target deceleration based on the changed set value of the target vehicle speed and the actual vehicle speed of the vehicle, and increase the gear ratio of a transmission interposed between the drive source and a drive shaft in the case of the target deceleration being predicted to be unachievable only by restriction of the amount of fuel injection.

The follow-up control unit in the follow-up mode based on vehicle speed may ease the follow-up by changing the set value of the target vehicle speed to a value that is less than the current set value.

In the case of the situation in which the preceding vehicle is predicted to decelerate being detected and the execution of a braking operation not being detected in the follow-up mode based on inter-vehicle distance, the follow-up control unit may release or change the set value of the target inter-vehicle distance.

In the case of the vehicle being provided with an internal combustion engine and an electric motor capable of executing regenerative braking control as a drive source, and in the case of the situation in which the preceding vehicle is predicted to decelerate being detected and the execution of a braking operation not being detected in the follow-up mode based on inter-vehicle distance, the follow-up control unit may restrict the amount of fuel injection to the internal combustion engine and execute the regenerative braking control, and increase the regenerative amount of the regenerative braking control in the case of the inter-vehicle distance between the vehicle and the preceding vehicle not widening.

In the case of the vehicle being provided with an internal combustion engine as a drive source, and in the case of the situation in which the preceding vehicle is predicted to decelerate being detected and the execution of a braking operation not being detected in the follow-up mode based on inter-vehicle distance, the follow-up control unit may restrict the amount of fuel injection to the internal combustion engine, and increase the gear ratio of a transmission interposed between the drive source and a drive shaft in the case of the inter-vehicle distance between the vehicle and the preceding vehicle not widening.

The follow-up control unit in the follow-up mode based on inter-vehicle distance may ease the follow-up by changing the set value of the target inter-vehicle distance to a value that is greater than the current set value.

The forward monitoring unit may monitor the information in the advancing direction based on imaging information provided by a camera.

The forward monitoring unit may identify a traffic light ahead and an illuminated color of the traffic light.

The forward monitoring unit may identify an obstacle ahead.

The forward monitoring unit may identify the illumination of a brake lamp of the preceding vehicle based on the imaging information provided by the camera.

Another aspect of the present disclosure provides a vehicle control method that executes follow-up control by a follow-up mode based on inter-vehicle distance in which cruise control is performed based on a target inter-vehicle distance and a follow-up mode based on vehicle speed in which cruise control is performed based on a target vehicle speed. The vehicle control method includes: monitoring information in the advancing direction of a vehicle to which the vehicle control method is applied, and easing the follow-up in the follow-up control and executing a deceleration operation of the vehicle when at least one of a situation in which a preceding vehicle is predicted to decelerate and execution of a braking operation of the preceding vehicle is detected based on the information in the advancing direction.

### BRIEF DESCRIPTION OF THE DRAWINGS

FIG. 1 is a block diagram illustrating a basic configuration of a power system of a vehicle according to an implementation of the present disclosure;

FIG. 2 illustrates an example of regenerative coordination control according to the implementation;

FIG. 3 is a flowchart illustrating a process of the regenerative coordination control according to the implementation;

FIG. 4 is a flowchart illustrating the process of significantly easing follow-up in a follow-up mode based on vehicle speed;

FIG. 5 is a flowchart illustrating the process of slightly easing the follow-up in the follow-up mode based on vehicle speed;

FIG. 6 is a flowchart illustrating the process of slightly easing the follow-up in the follow-up mode based on vehicle speed;

FIG. 7 is a time chart for describing the execution state of the regenerative coordination control; and

FIG. 8 illustrates effects of the regenerative coordination control process.

### DETAILED DESCRIPTION

Hereinafter, preferred examples of the present disclosure will be described in detail with reference to the appended drawings. Note that, in this specification and the appended drawings, structural elements that have substantially the same function and structure are denoted with the same reference numerals, and repeated explanation of these structural elements is omitted.

### 1. Basic Configuration of Power System

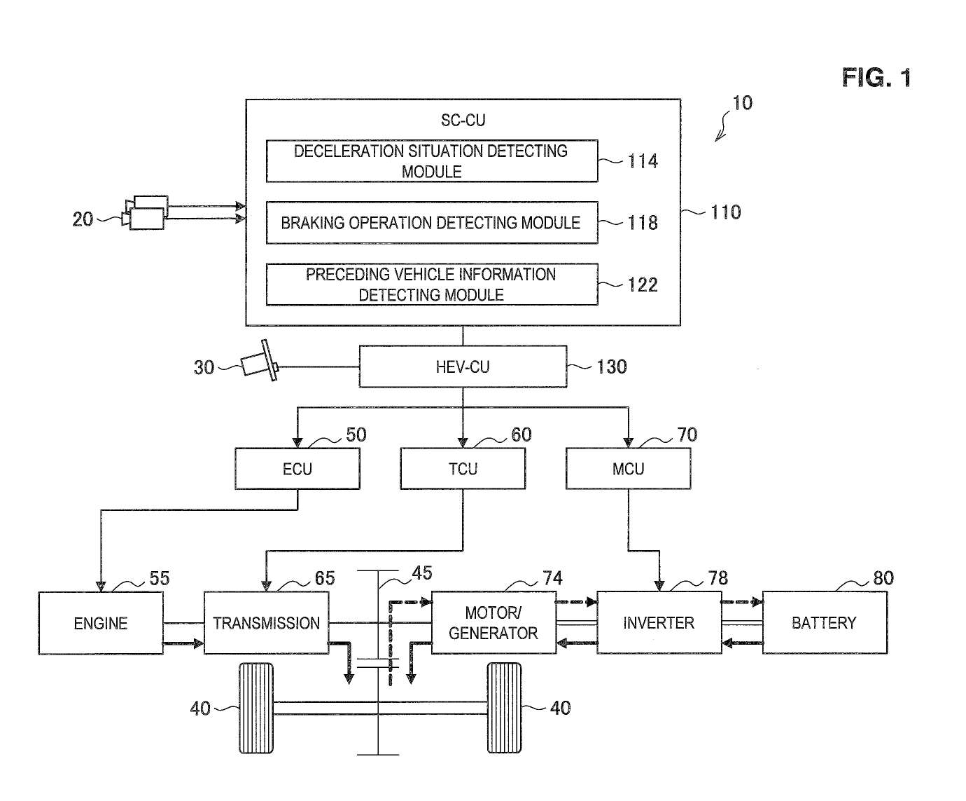

First, a basic configuration of a power system of a vehicle shall be described. FIG. 1 illustrates a basic system configuration of a power system of a vehicle 10 according to the present implementation. The vehicle 10 according to the present implementation is a hybrid electric vehicle (HEV) that has an engine 55 and a motor/generator 74 as drive sources.

As illustrated in FIG. 1, the engine 55 is an internal combustion engine that generates drive force with gasoline or the like serving as fuel. An automatic transmission 65 is connected with the output side of the engine 55.

The motor/generator 74 has a function that converts electrical energy to mechanical energy, and a function that converts mechanical energy to electrical energy (a regenerative function). Also, the motor/generator 74 has a motor generator travel mode that charges a battery 80 by absorbing the output of the engine 55 and converting it to electrical power, and a regenerative braking mode that converts deceleration energy that is lost as heat energy during deceleration to electrical power for charging the battery 80. In the regenerative braking mode, electrical power is generated in the motor/generator 74 by the rotation of drive wheels 40, and braking force to the drive wheels 40 is produced.

The motor/generator 74 is connected to the battery 80 via an inverter 78 that converts direct current to alternating current and vice versa. The inverter 78, during drive force generation by the motor/generator 74, converts the direct current voltage from the battery 80 to alternating current voltage to drive the motor/generator 74. In addition, the inverter 78, during charging of the battery 80, converts the regenerative power produced by the motor/generator 74 to direct current voltage to charge the battery 80. The operation of the motor/generator 74 is thus switched by control of the inverter 78.

The drive force that is output from the motor/generator 74 is transmitted to the drive wheels 40 via a drive shaft 45. Also, the drive force that is output from the engine 55 is transmitted to the drive wheels 40 via the automatic transmission 65 and the drive shaft 45. The automatic transmission 65 adjusts the drive force that is transmitted to the drive shaft 45 by changing the gear ratios. A clutch mechanism, not illustrated, is provided between the engine 55 and the automatic transmission 65. The engine 55 is disconnected from the automatic transmission 65 by the clutch mechanism being disengaged, whereby only the motor/generator 74 is connected to the drive wheels 40 as a power source. Also, the engine 55 is connected with the automatic transmission 65 by the clutch mechanism being engaged, whereby the engine 55 and the motor/generator 74 are connected to the drive wheels 40 as power sources.

### 2. Electronic Control System

### 2.1 Basic Constitution

Next, an electronic control system that controls the power system of the vehicle 10 shall be described. As illustrated in FIG. 1, the electronic control system is composed of a plurality of control units that are connected with a not illustrated communication bus such as a Controller Area Network (CAN) bus. The engine 55, the automatic transmission 65, and the motor/generator 74 are controlled by coordination control via this plurality of control units.

In the present implementation, the electronic control system is provided with an engine control unit (ECU) 50, an automatic transmission control unit (TCU) 60, a motor control unit (MCU) 70, an image processing unit (SC-CU) 110, and a hybrid control unit (HEY-CU) 130. Each control unit mainly includes a microcomputer.

These control units 50, 60, 70, 110, 130 mutually exchange control information such as various operation values and control parameter information detected by various sensors via the onboard network formed by the communication bus. These control units 50, 60, 70, 110, 130 execute follow-up control including engine control, motor control, and automatic transmission control.

For example, the SC-CU 110 receives imaging information signals of a stereo camera assembly 20. Also, the HEV-CU 130 receives the signals of a cruise-control switch 30, an accelerator sensor that detects the accelerator operation (depression amount of the accelerator pedal, accelerator opening) by the driver, and a brake sensor that detects the braking operation (depression amount of the brake pedal) by the driver.

The ECU 50, TCU 60, and MCU 70 control the engine 55, the automatic transmission 65, and the inverter 78 of the motor/generator 74, respectively. The ECU 50, TCU 60, and MCU 70 execute control based on requests from the HEV-CU 130 at least during the execution of follow-up control.

### 2.2 Image Processing Unit

While the SC-CU 110 receives imaging information from the stereo camera assembly 20 as shown in FIG. 1, the SC-CU 110 also receives a vehicle speed V of the vehicle 10 via the communication bus. Based on the imaging information by the stereo camera assembly 20, the SC-CU 110 calculates the existence of a traffic light, the illuminated color of the traffic light, the distance to the traffic light, the existence of a preceding vehicle, the illuminated state of the brake lamps of the preceding vehicle, the inter-vehicle distance with the preceding vehicle and changes in the inter-vehicle distance, the existence of an obstacle, the distance to the obstacle and changes in the distance. This SC-CU 110 serves as the forward monitoring unit of the appended claims in the present implementation.

The stereo camera assembly 20 which is connected with the SC-CU 110 has one left-right pair of CCD cameras that each employ a solid-state image sensor, such as a charge-coupled device (CCD). Also, the image sensor of the CCD camera is capable of color imaging. These left and right CCD cameras are attached at the front of the ceiling in the vehicle compartment with a fixed interval, and perform stereo image capturing of objects outside the vehicle from different viewpoints. The stereo camera assembly 20 and the SC-CU 110 are provided in the vehicle compartment as an integrated unit.

The SC-CU 110 generates distance information by the principle of triangulation from the deviation of a corresponding position, based on a stereo image pair in the advancing direction of the vehicle 10 captured by the stereo camera assembly 20. The SC-CU 110 performs a well-known grouping process on this distance information, and the distance information subjected to the grouping process is compared with three-dimensional solid data set in advance, whereby a traffic light, a preceding vehicle, an obstacle and other objects are detected. Obstacles include a person, and a guardrail, for example. The SC-CU 110, in the case of having detected such an object, computes a relative distance D between the vehicle 10 and the object, and moving speed Vf of the object (that is, the sum of the change rate of the relative distance D and vehicle speed V of the vehicle 10).

Specifically, as shown in FIG. 1, the SC-CU 110 according to the present implementation includes a deceleration situation detecting module 114, a braking operation detecting module 118, and a preceding vehicle information detecting module 122. Each of these modules is realized by the execution of a program by a microcomputer.

Among these, the preceding vehicle information detecting module 122 detects the existence of a preceding vehicle as a solid object, and computes an inter-vehicle distance D₁ between the preceding vehicle and the vehicle 10, and moving speed Vf₁ of the preceding vehicle (the sum of the change rate of the inter-vehicle distance D₁ and the vehicle speed V of the vehicle 10). The information relating to the detected preceding vehicle is output to the HEV-CU 130.

Also, the deceleration situation detecting module 114 of the SC-CU 110 recognizes causes that could lead to deceleration of the preceding vehicle, such as traffic lights, obstacles and the like, as solid objects. In the case of having recognized a traffic light, the deceleration situation detecting module 114 identifies the illuminated color of the traffic light from among red, yellow and green. The illuminated color of the traffic light can be identified by, for example, processing the stereo images to specify a signal lamp of the traffic light, and then extracting the color component of the corresponding region of the stereo images prior to the processing. The information of the detected traffic light or obstacle is output to the HEV-CU130.

Also, in the case of a preceding vehicle being recognized as a solid object, the braking operation detecting module 118 of the SC-CU 110 identifies whether the brake lamps of the preceding vehicle are illuminated. The illumination of the brake lamps can be identified by, for example, processing the stereo images to specify the brake lamps of the preceding vehicle, and then extracting the color component and luminance of the corresponding regions of the stereo images prior to the processing. The information of the detected brake lamps is output to the HEV-CU 130.

### 2.3 Hybrid Control Unit

The HEV-CU 130 performs follow-up control of the vehicle 10 by controlling the output torque of the engine 55, the gear ratio of the automatic transmission 65, and the output torque of the motor/generator 74 via the ECU 50, the TCU 60 and the MCU 70, in the state of the cruise-control switch 30 being turned ON. This HEV-CU 130 serves as the follow-up control unit of the appended claims in the present implementation.

The cruise-control switch 30 is, for example, provided in the steering wheel of the vehicle 10, and the ON/OFF switching operation thereof is performed by the driver. Also, the HEV-CU 130 stops the follow-up control in the case of a braking operation being performed by the driver during execution of the follow-up control.

When the cruise-control switch 30 is ON, the HEV-CU 130 executes follow-up control based on a target inter-vehicle distance (follow-up mode based on inter-vehicle distance) in the case of a preceding vehicle being detected by the SC-CU 110, and the inter-vehicle distance D₁ being less than an inter-vehicle follow-up distance Dₜₕᵣₑ₁. On the other hand, when the cruise-control switch 30 is ON, the HEV-CU 130 executes follow-up control based on a target vehicle speed that is set by the driver (follow-up mode based on vehicle speed) in the case of a preceding vehicle not having been detected by the SC-CU 110. In addition, when the cruise-control switch 30 is ON, the HEV-CU 130 executes follow-up control based on the target vehicle speed that is set by the driver in the case of a preceding vehicle having been detected, and the inter-vehicle distance D₁ being equal to or greater than the inter-vehicle follow-up distance Dₜₕᵣₑ₁.

The follow-up mode based on inter-vehicle distance is a cruise control mode that converges the inter-vehicle distance D₁ to a target inter-vehicle distance value D_{trg} while the inter-vehicle distance D₁ with the preceding vehicle is less than the inter-vehicle follow-up distance Dₜₕᵣₑ₁. It is possible to set the target inter-vehicle distance value D_{trg} to a different value in accordance with the vehicle speed V of the vehicle 10. During execution of follow-up control by the follow-up mode based on inter-vehicle distance (follow-up control based on inter-vehicle distance), the HEV-CU 130 calculates a target acceleration in order to converge the inter-vehicle distance D₁ to the target inter-vehicle distance value D_{trg}. Based on this calculated target acceleration, the HEV-CU 130 computes a target engine output torque, a target gear ratio, and a target motor torque, and outputs instructions to the ECU 50, the TCU 60, and the MCU 70.

The follow-up mode based on vehicle speed is a cruise control mode that converges the vehicle speed V to a target vehicle speed value V_{trg} that is set by the driver, while a preceding vehicle is not detected, or while the inter-vehicle distance D₁ with the preceding vehicle being equal to or greater than the inter-vehicle follow-up distance Dₜₕᵣₑ₁. During execution of the follow-up control by the follow-up mode based on vehicle speed (follow-up control based on vehicle speed), the HEV-CU 130 calculates a target acceleration for converging the vehicle speed V of the vehicle 10 to the target vehicle speed value V_{trg}. Based on the calculated target acceleration, the HEV-CU 130 computes a target engine output torque, a target gear ratio, and a target motor torque, and outputs instructions to the ECU 50, the TCU 60, and the MCU 70.

In the case of a situation of the preceding vehicle being likely to decelerate or the illumination of the brake lamps of the preceding vehicle being detected based on information output from the SC-CU 110, the HEV-CU 130 eases the follow-up in the follow-up control which is being executed. Thereby, before the preceding vehicle decelerates in the follow-up control based on inter-vehicle distance, or prior to the vehicle 10 approaching the preceding vehicle in the follow-up control based on vehicle speed, the vehicle 10 gently decelerates. Accordingly, sudden deceleration of the vehicle 10 is avoided.

In the follow-up control based on inter-vehicle distance, the follow-up is eased by releasing the target inter-vehicle distance value D_{trg} that has been set, or changing it to an eased target inter-vehicle distance D_{trg′} that is a larger value. The eased target inter-vehicle distance D_{trg′} can be made a value that is determined in accordance with the inter-vehicle distance D₁ with the preceding vehicle, a distance D₂ to an obstacle such as a traffic light, and the vehicle speed V of the vehicle 10.

Also, in the follow-up control based on vehicle speed, the follow-up is eased by releasing the target vehicle speed value V_{trg} that been set, or changing it to an eased target vehicle speed V_{trg}′ that is a smaller value. A settable range of the eased target vehicle speed V_{trg}′ is decided in advance in accordance with the current vehicle speed V of the vehicle 10.

When the HEV-CU 130 changes the target values D_{trg} and V_{trg} to the eased target values D_{trg′} and V_{trg′}, a set value may be added to or subtracted from the current target values D_{trg} and V_{trg}, or the current target values D_{trg} and V_{trg} may be multiplied by a fixed coefficient. Alternatively, in accordance with the vehicle speed V of the vehicle 10, the HEV-CU 130 may vary the value to be added or subtracted, or the coefficient to be multiplied. Moreover, depending on the degree of easing of the follow-up, the HEV-CU 130 may vary the target values D_{trg} and V_{trg}.

Also, the HEV-CU 130 executes any one or more of fuel injection cut control, gear ratio increase control, regenerative braking control by the ECU 50, the ECU 60, and MCU 70, in conjunction with the releasing or changing of the target values D_{trg} and V_{trg}. When easing the follow-up, the HEV-CU 130 according to the present implementation first executes regenerative braking control with a comparatively weak regenerative amount and fuel injection cut control. In the case of further deceleration being required, the regenerative amount of the regenerative braking control is increased, or the gear ratio of the automatic transmission 65 is increased.

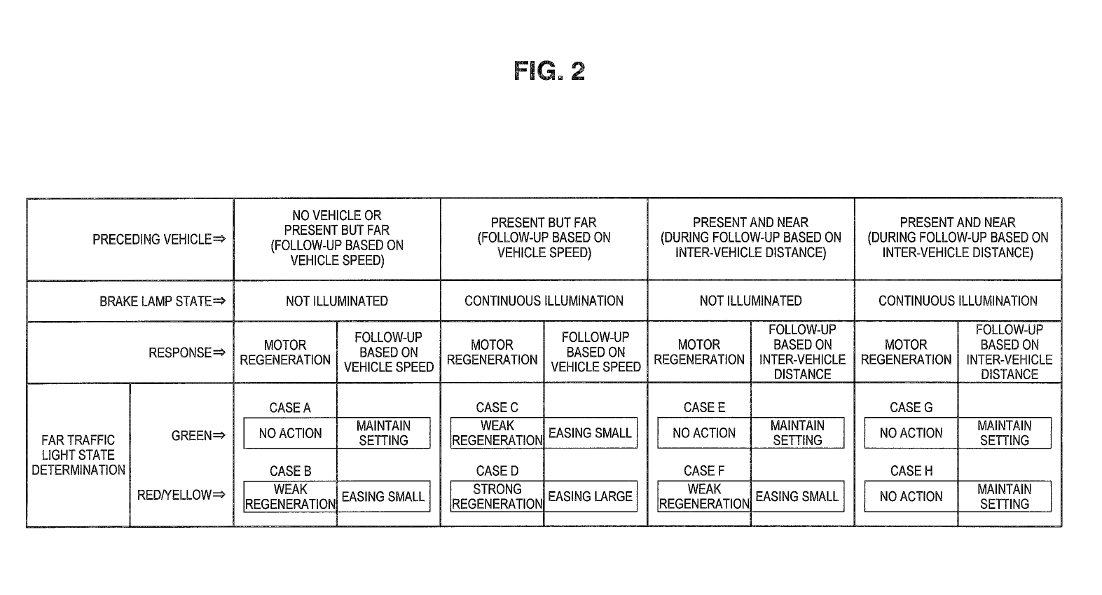

FIG. 2 illustrates one example of a pattern of regenerative coordination control involving regenerative braking control, which is executed for deceleration control of the vehicle 10. In FIG. 2, a preceding vehicle classification of “no vehicle” indicates that a preceding vehicle has not been detected, while a preceding vehicle classification of “present but far” indicates that a preceding vehicle has been detected, but that the inter-vehicle distance D₁ is equal to or greater than the inter-vehicle follow-up distance Dₜₕᵣₑ₁. In addition, a preceding vehicle classification of “present and near” indicates that a preceding vehicle has been detected, and the inter-vehicle distance D₁ thereof is less than the inter-vehicle follow-up distance Dₜₕᵣₑ₁.

Follow-up control based on vehicle speed is performed in the case of the preceding vehicle classification of “no vehicle or present but far”. At this time, in the case of the brake lamps of the preceding vehicle not being illuminated, and a traffic light that is far away not being a red light or a yellow light, the HEV-CU 130 continues the follow-up control based on vehicle speed without executing regenerative coordination control (Case A). When follow-up control based on vehicle speed is being performed, in the case of the brake lamps of the preceding vehicle not being illuminated, and a traffic light that is far away being a red light or a yellow light, the HEV-CU 130 slightly eases the follow-up and executes regenerative braking control with a weak regenerative amount (Case B).

When follow-up control based on vehicle speed is performed in the case of the preceding vehicle classification of “present but far”, in the case of the brake lamp illumination of the preceding vehicle being continuous and a traffic light that is far away not being a red light or a yellow light, the HEV-CU 130 slightly eases the follow-up, and executes regenerative braking control with a weak regenerative amount (Case C). When follow-up control based on vehicle speed is performed in the case of a preceding vehicle being “present but far”, in the case of the brake lamp illumination of the preceding vehicle being continuous and a traffic light that is far away being a red light or a yellow light, the HEV-CU 130 significantly eases the follow-up and executes regenerative braking control with a strong regenerative amount (Case D).

That is to say, in the state of the inter-vehicle distance Di with the preceding vehicle Di being long to some extent, the HEV-CU 130 executes regenerative coordination control in the case of the brake lamp illumination of the preceding vehicle being continuous or in the case of the traffic light being a red light or a yellow light. At this time, in the case of the brake lamp illumination of the preceding vehicle being continuous, and a traffic light that is far away being a red light or a yellow light, the possibility of the preceding vehicle decelerating is higher, and thus regenerative coordination control is executed so that relatively greater deceleration is obtained.

With regard to the state of a traffic light, in the both cases of a traffic light that is near being a red light and a yellow light, the vehicle 10 should be quickly decelerated, and the follow-up in the follow-up control should not be eased. Therefore, the state of a far traffic light is monitored.

In the case of the preceding vehicle classification of “present and near”, follow-up control based on inter-vehicle distance is performed. At this time, in the case of the brake lamps of the preceding vehicle not being illuminated and a traffic light that is far away not being a red light or a yellow light, the HEY-CU 130 continues the follow-up control based on inter-vehicle distance without executing regenerative coordination control (Case E). When follow-up control based on inter-vehicle distance is being performed, in the case of the brake lamps of the preceding vehicle not being illuminated, and a traffic light that is far away being a red light or a yellow light, the HEY-CU 130 slightly eases the follow-up and executes regenerative braking control with a weak regenerative amount (Case F).

In the case of the brake lamp illumination of the preceding vehicle being continuous when follow-up control based on inter-vehicle distance is being performed, regardless of the state of a traffic light that is far away, the HEY-CU 130 continues the follow-up control based on inter-vehicle distance without executing regenerative coordination control (Cases G and H).

That is to say, in the case of the brake lamp illumination of the preceding vehicle being continuous in the state of the inter-vehicle distance Di with the preceding vehicle being short, it is a situation in which the vehicle 10 must be quickly decelerated, and thus the HEY-CU 130 does not execute regenerative coordination control. On the other hand, in the case of the brake lamps of the preceding vehicle not being illuminated, and only the traffic light being a red light or a yellow light, the HEY-CU 130 executes regenerative coordination control.

### 3. Regenerative Coordination Control Process

Hereinabove, the constitutions of the power system and electronic control system of the vehicle 10 according to the present implementation have been described. Next, a process of the regenerative coordination control of the present implementation shall be described. Note that the example of the regenerative coordination control process described below performs regenerative coordination control based on information of the preceding vehicle and a traffic light.

### 3.1 Basic Routine

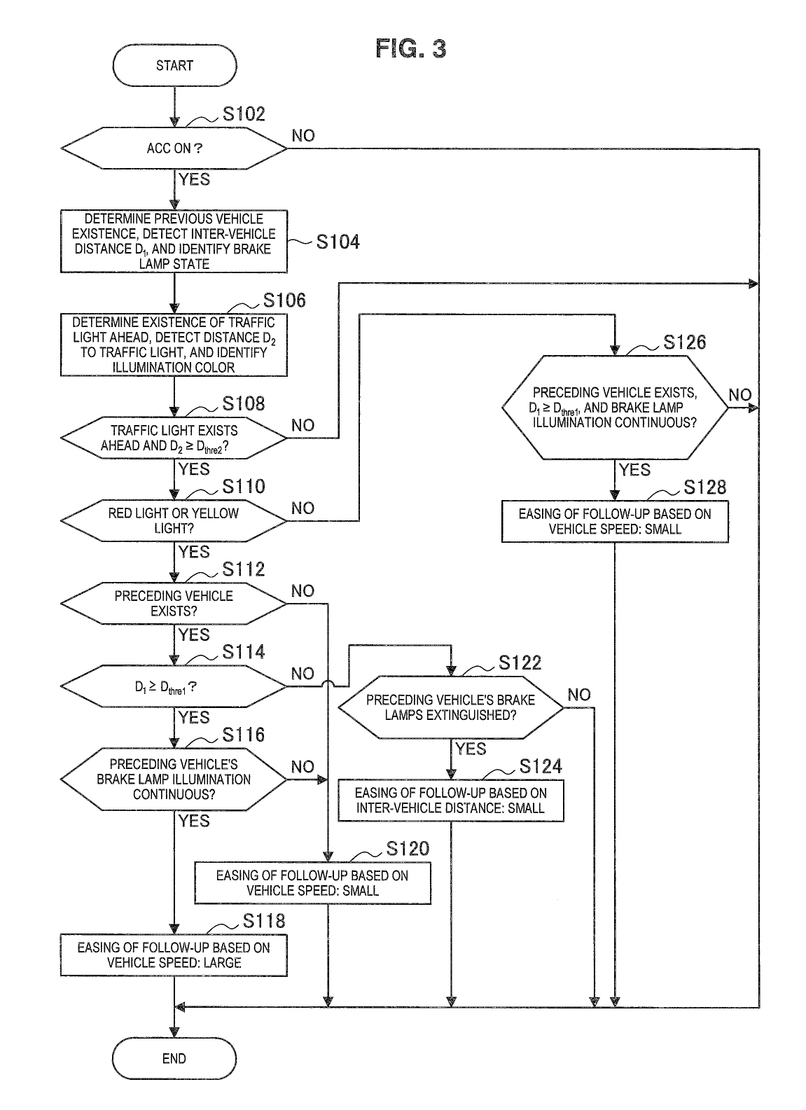

FIG. 3 is a flowchart that illustrates an example of the regenerative coordination control process according to the present implementation. First, the HEY-CU 130 determines whether or not the cruise-control (ACC) switch 30 has been turned ON (S102). In the case of the cruise-control switch 30 being OFF (S102: No), the HEY-CU 130 terminates the process without performing regenerative coordination control.

When the cruise-control switch 30 is ON (S102: Yes), the braking operation detecting module 118 of the SC-CU 110, based on the imaging information of the stereo camera assembly 20, performs determination of the existence of a preceding vehicle, computation of the inter-vehicle distance D₁ with the preceding vehicle, and identification of the illumination state of the brake lamps (S104).

Next, the deceleration situation detecting module 114 of the SC-CU 110 performs determination of the existence of a traffic light ahead, computation of the distance D₂ to the traffic light, and identification of the illumination color of the traffic light (S106).

Next, the HEY-CU 130 determines whether or not a traffic light exists ahead, and whether the distance D₂ to the traffic light is equal to or greater than a predetermined value Dₜₕᵣₑ₂ (S108). In the case of a traffic light not existing, or a traffic light existing but the distance D₂ to the traffic light being less than the predetermined value Dₜₕᵣₑ₂ (S108: No), the HEY-CU 130 terminates the process without performing regenerative coordination control.

On the other hand, in the case of there being a traffic light ahead, and the distance D₂ to the traffic light being equal to or greater than the predetermined value Dₜₕᵣₑ₂ (S108: Yes), the HEY-CU 130 determines whether or not the traffic light is a red light or a yellow light (S110). In the case of the traffic light being a red light or a yellow light (S110: Yes), the HEV-CU 130 determines whether or not a preceding vehicle exists (S112). In the case of a preceding vehicle not existing (S112: No), follow-up control based on vehicle speed is executed in the vehicle 10, and the HEV-CU 130 slightly eases the follow-up in the follow-up control based on vehicle speed and decelerates the vehicle 10 so that the vehicle 10 does not undergo sudden deceleration when it stops at the position of a far traffic light (S120). The case of the process proceeding to S120 following a “No” determination in S112 corresponds to Case B in FIG. 2. The processes of significantly or slightly easing the follow-up in the follow-up control based on vehicle speed shall be described below.

On the other hand, in the case of a preceding vehicle existing (S112: Yes), the HEV-CU 130 determines whether or not the inter-vehicle distance D₁ is equal to or greater than the inter-vehicle follow-up distance Dₜₕᵣₑ₁ (S114). In the case of the inter-vehicle distance D₁ being equal to or greater than the inter-vehicle follow-up distance Dₜₕᵣₑ₁ (S114: Yes), the HEV-CU 130 moreover determines whether or not the brake lamp illumination of the preceding vehicle is continuous (S116). This determination is performed by determining, for example, whether or not the brake lamp illumination is equal to or greater than a predetermined time Tₜₕᵣₑ. The predetermined time Tₜₕᵣₑ can be set to, for example, one to three seconds. Note that, if shorter than one second, there is a risk of the deceleration of the vehicle 10 being continued even after the preceding vehicle releases the brake operation, and if longer than 3 seconds, there is a risk of the vehicle 10 drawing too close to the preceding vehicle until the deceleration of the vehicle 10 begins. Note that in the state of the process proceeding to S114, follow-up control based on vehicle speed is executed in the vehicle 10.

In the case of the brake lamp illumination of the preceding vehicle being continuous (S116: Yes), the HEV-CU 130 significantly eases the follow-up in the follow-up control based on vehicle speed and decelerates the vehicle 10 (S118). The case of the process proceeding to S118 corresponds to Case D of FIG. 2. On the other hand, in the case of the brake lamps of the preceding vehicle not being illuminated or being extinguished soon after illumination (S116: No), the HEV-CU 130 slightly eases the follow-up in the follow-up control based on vehicle speed and decelerates the vehicle 10 (S120). The case of the process proceeding to S120 following a “No” determination in S116 corresponds to Case B of FIG. 2. The processes of significantly or slightly easing the follow-up in the follow-up control based on vehicle speed shall be described below.

On the other hand, in the aforementioned S114, in the case of there being a preceding vehicle but the inter-vehicle distance Di being less than the inter-vehicle follow-up distance Dₜₕᵣₑ₁ (S114: No), the HEV-CU 130 determines whether or not the brake lamps of the preceding vehicle are in an extinguished state (S122). Note that in the state of the process proceeding to S122 with a preceding vehicle existing, follow-up control based on inter-vehicle distance is executed in the vehicle 10.

In the case of the brake lamps of the preceding vehicle being illuminated (S122: No), it is necessary to quickly decelerate the vehicle 10, and thus the HEV-CU 130 terminates the process without executing regenerative coordination control. That is, the vehicle 10 is decelerated by normal follow-up control based on inter-vehicle distance. The case of “No” in S122 corresponds to Case H of FIG. 2. On the other hand, in the case of the brake lamps of the preceding vehicle not being illuminated or being extinguished soon after illumination (S122: Yes), the HEV-CU 130 slightly eases the follow-up in the follow-up control based on inter-vehicle distance and decelerates the vehicle 10 (S124). The process of slightly easing the follow-up in the follow-up control based on inter-vehicle distance shall be described below. The case of reaching S124 corresponds to Case F of FIG. 2.

Moreover, in the case of the traffic light not being a red light or a yellow light in the aforementioned S110 (S110: No), the HEV-CU 130 determines whether or not a preceding vehicle exists, the inter-vehicle distance D₁ is equal to or greater than the inter-vehicle follow-up distance Dₜₕᵣₑ₁, and the brake lamp illumination of the preceding vehicle is continuous (S126). Whether or not the brake lamp illumination is continuous can be determined in the same manner as S116.

In the case of a preceding vehicle not existing, the case of a preceding vehicle existing but the inter-vehicle distance D₁ being less than the inter-vehicle follow-up distance Dₜₕᵣₑ₁, or the case of a preceding vehicle existing without the brake lamp illumination being continuous (S126: No), the HEV-CU 130 terminates the process without executing regenerative coordination control. The case of “No” in S126 corresponds to any of Cases A, E, and G of FIG. 2. On the other hand, in the case of the inter-vehicle distance D₁ with the preceding vehicle being equal to or greater than the inter-vehicle follow-up distance Dₜₕᵣₑ₁, and the brake lamp illumination being continuous (S126: Yes), the HEV-CU 130 slightly eases the follow-up in the follow-up control based on vehicle speed and decelerates the vehicle 10 (S128). The case of reaching S128 corresponds to Case C of FIG. 2. The process of slightly easing the follow-up in the follow-up control based on vehicle speed shall be described below.

### 3.2 Routine for Large Easing of Follow-up Based on Vehicle Speed

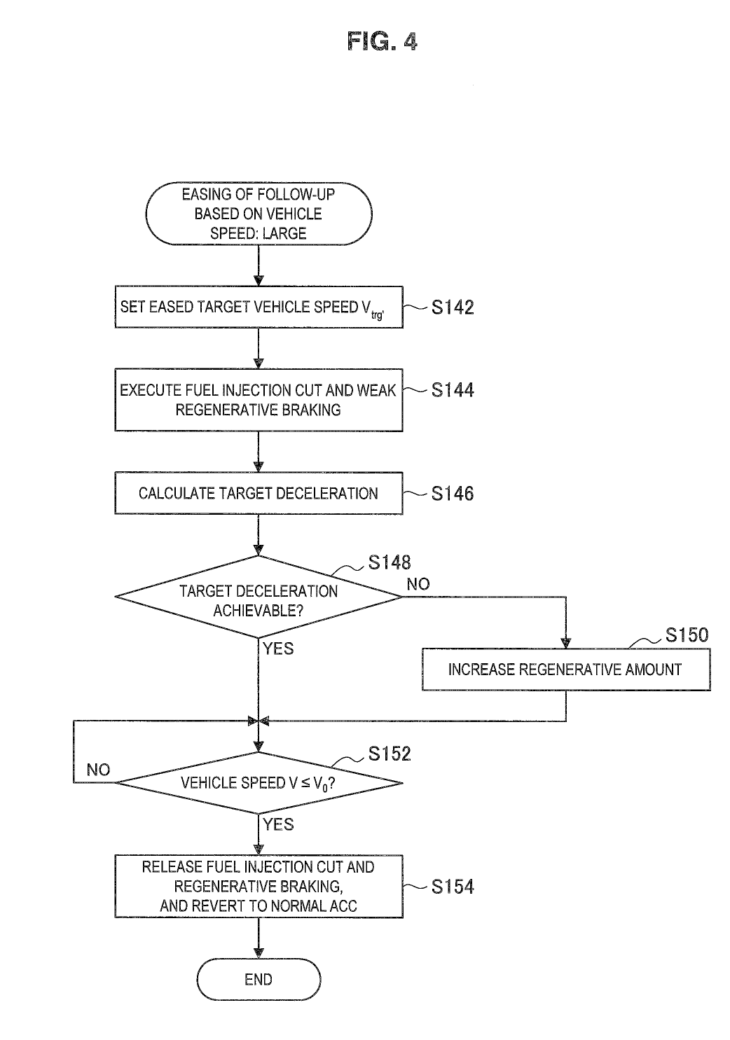

FIG. 4 is a flowchart illustrating the process of significantly easing the follow-up in the follow-up control based on vehicle speed (S118 of FIG. 3). When significantly easing the follow-up in follow-up control based on vehicle speed, the HEV-CU 130 sets the eased target vehicle speed V_{trg′} so as to be smaller than the current target vehicle speed value V_{trg} (S142). The eased target vehicle speed V_{trg′} can be determined in accordance with the inter-vehicle distance D₁ with the preceding vehicle, the distance D₂ to a traffic light, and the vehicle speed V of the vehicle 10, and the like. For example, the eased target vehicle speed V_{trg′} may be the upper limit value of the set range of an eased target vehicle speed set in advance.

Next, the HEV-CU 130 executes fuel injection cut control by the ECU 50, and regenerative braking control with a weak regenerative amount by the MCU 70 (S144).

Then, the HEV-CU 130 determines the target deceleration based on the eased target vehicle speed V_{trg′} and the current vehicle speed V of the vehicle 10 (S146). The target deceleration that is set at this time is determined so as not to lead to a sudden deceleration, with the inter-vehicle distance D₁ with the preceding vehicle or the distance D₂ to a traffic light being taken into consideration.

Next, the HEV-CU 130 determines whether or not it is possible to achieve the target deceleration only by fuel injection cut control and the current regenerative braking control (S148). If it is difficult to achieve the target deceleration (S148: No), the HEV-CU 130 increases the regenerative amount of the regenerative braking control with the MCU 70 (S150).

If it is possible to achieve the target deceleration only by fuel injection cut control and regenerative braking control with a weak regenerative amount (S148: Yes), or in the case of the regenerative amount of the regenerative braking control being increased (S150), the HEV-CU 130 then stands by until the vehicle speed V of the vehicle 10 becomes equal to or less than the lower limit value V₀ of the set range of the eased target vehicle speed (S152).

When the vehicle speed V of the vehicle 10 becomes equal to or less than the lower limit value V₀ of the set range of the target vehicle speed (S152: Yes), the HEV-CU 130 terminates the fuel injection cut control and regenerative braking control and resumes the normal follow-up control (S154). Thereby, the control that significantly eases the follow-up in the follow-up control based on vehicle speed ends. At this time, the target vehicle speed value V_{trg} reverts to the originally set value.

As described above, in a situation in which deceleration of the preceding vehicle is predicted, the follow-up in the follow-up control based on vehicle speed being significantly eased, whereby it is possible to start a deceleration operation without the vehicle 10 accelerating or prior to the vehicle 10 drawing close to the preceding vehicle. Accordingly, comparatively gentle deceleration of the vehicle 10 can be made, and thus it is possible to prevent a drop in drivability. Also, since the deceleration operation of the vehicle 10 is achieved by fuel injection cut control and regenerative braking control, it is possible to achieve an improvement in fuel efficiency.

### 3.3 Routine for Small Easing of Follow-up Based on Vehicle Speed

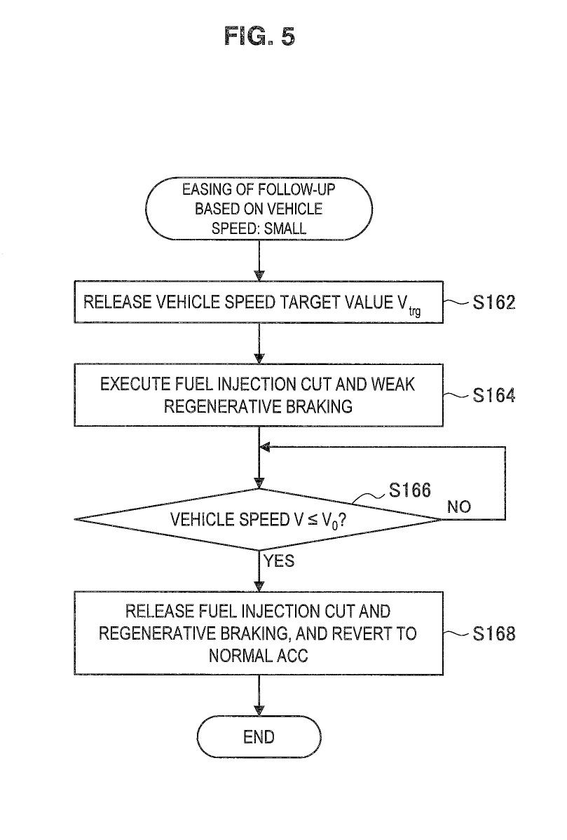

FIG. 5 is a flowchart that illustrates the process for slightly easing the follow-up in the follow-up control based on vehicle speed (S120, S128 in FIG. 3). When slightly easing the follow-up in the follow-up control based on vehicle speed, the HEV-CU 130 releases the current target vehicle speed value V_{trg} (S162).

The process of slightly easing the follow-up in the follow-up control based on vehicle speed is executed when either one of the conditions of a far traffic light being a red light or a yellow light, or the brake lamp illumination being continuous in a preceding vehicle that is away by a distance equal to or greater than the inter-vehicle follow-up distance Dₜₕᵣₑ₁ is satisfied. Since one of the conditions, once satisfied, may subsequently be released, and the driver may even reaccelerate the vehicle 10, the eased target vehicle speed is not set.

Next, the HEV-CU 130 executes fuel injection cut control by the ECU 50, and regenerative braking control with a weak regenerative amount by the MCU 70 (S164).

Next, the HEV-CU 130 stands by until the vehicle speed V of the vehicle 10 becomes equal to or less than a predetermined value V₀ (S166). The predetermined value V₀ may, for example, be made the upper limit value of the set range of the eased target vehicle speed.

When the vehicle speed V of the vehicle 10 has become equal to or less than the predetermined value V₀ (S166: Yes), the HEV-CU 130 terminates the fuel injection cut control and regenerative braking control and resumes the normal follow-up control (S168). Thereby, the control that slightly eases the follow-up in the follow-up control based on vehicle speed ends.

In this way, when slightly easing the follow-up in the follow-up control based on vehicle speed in a situation in which deceleration of the preceding vehicle is predicted, the torque demand of the engine 55 is lowered, and regenerative braking control with a weak regenerative amount is executed without setting the eased target vehicle speed V_{trg′}. Accordingly, the vehicle 10 undergoes a gentle deceleration operation, and thus it is possible to prevent a drop in drivability. Also, since the deceleration operation of the vehicle 10 is achieved by fuel injection cut control and regenerative braking control, it is possible to achieve an improvement in fuel efficiency.

### 3.4 Routine for Small Easing of Follow-up Based on Inter-Vehicle Distance

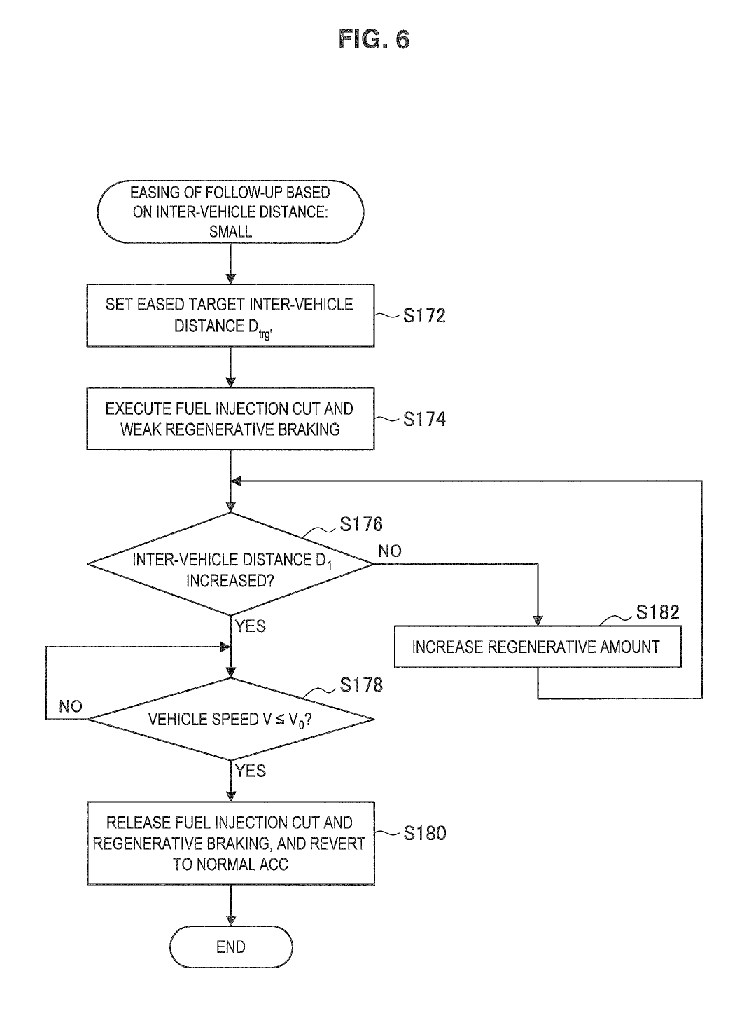

FIG. 6 is a flowchart illustrating the process for slightly easing the follow-up in follow-up control based on inter-vehicle distance (S124 in FIG. 3). First, when slightly easing the follow-up in the follow-up control based on inter-vehicle distance, the HEV-CU 130 sets the eased target inter-vehicle distance D_{trg′} so as to be greater than the current target inter-vehicle distance value D_{trg} (S172). The eased target inter-vehicle distance D_{trg′} is determined based on the inter-vehicle distance D₁ with the preceding vehicle, the distance D₂ to a traffic light, the vehicle speed V of the vehicle 10, and the like.

Next, the HEV-CU 130 executes fuel injection cut control by the ECU 50 and executes regenerative braking control with a weak regenerative amount by the MCU 70 (S174).

Next, the HEV-CU 130 determines whether or not the inter-vehicle distance D₁ with the preceding vehicle has been increased (S176). In the case of the inter-vehicle distance D₁ not having been increased (S176: No), the HEV-CU 130 increases the regenerative braking amount of the regenerative braking control by the MCU 70 (S182). On the other hand, in the case of the inter-vehicle distance D₁ having been increased (S176: Yes), the HEV-CU 130 stands by until the vehicle speed V of the vehicle 10 becomes equal to or less than the lower limit value Vo of the set range of the eased target vehicle speed (S178).

When the vehicle speed V of the vehicle 10 has become equal to or less than the lower limit value V₀ of the set range of the eased target vehicle speed (S178: Yes), the HEV-CU 130 terminates the fuel injection cut control and the regenerative braking control and restores the normal follow-up control (S180). Thereby, the control that slightly eases the follow-up in follow-up control based on inter-vehicle distance ends.

In this way, by slightly easing the follow-up in follow-up control based on inter-vehicle distance in a situation in which deceleration of the preceding vehicle is predicted, the vehicle 10 undergoes a comparatively gentle deceleration operation, and thus it is possible to prevent a drop in drivability. Also, since the deceleration operation of the vehicle 10 is achieved by fuel injection cut control and regenerative braking control, it is possible to achieve an improvement in fuel efficiency.

### 3.5 Time Charts

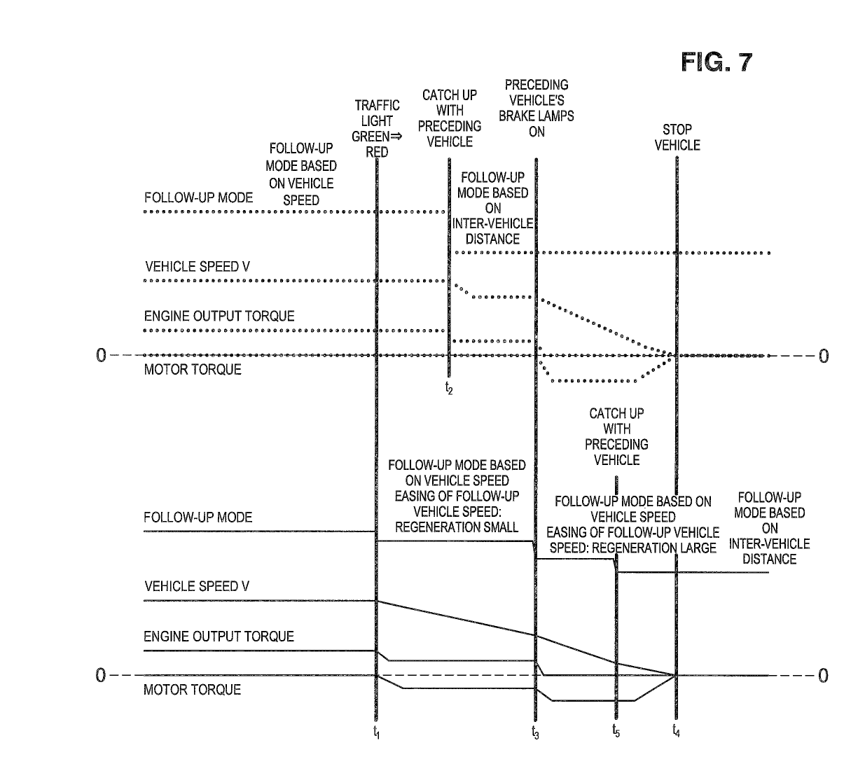

Next, a specific example in which regenerative coordination control of the present implementation is performed shall be described based on the time chart of FIG. 7. In the upper half of FIG. 7, the follow-up mode, vehicle speed, engine output torque (amount of fuel injection), and motor torque transition of conventional follow-up control are shown by dotted lines. In the lower half of FIG. 7, the follow-up mode, vehicle speed, engine output torque, and motor torque transition of the follow-up control in the case of regenerative coordination control of the present implementation being performed are shown by solid lines. The minus state of motor torque indicates the execution of regenerative control.

First, as illustrated in the upper half of FIG. 7, in the conventional follow-up control, when the inter-vehicle distance Di with the preceding vehicle is equal to or greater than the inter-vehicle follow-up distance Dₜₕᵣₑ₁, and follow-up control based on vehicle speed is executed, the normal follow-up control based on inter-vehicle distance is continued at time t₁ , even if a far traffic light changes from green to red.

Afterward, when the inter-vehicle distance D₁ between the vehicle 10 and the preceding vehicle becomes less than the inter-vehicle follow-up distance Dₜₕᵣₑ₁ at time t₂, the follow-up mode is switched from the follow-up mode based on vehicle speed to the follow-up mode based on inter-vehicle distance. Accompanying this, the engine output torque is lowered (fuel injection cut), and the vehicle speed V once decreases. Thereafter, the inter-vehicle distance D₁ is maintained at the target inter-vehicle distance value D_{trg} by the follow-up control based on inter-vehicle distance.

When the preceding vehicle commences a braking operation at time t₃, the engine output torque of the vehicle 10 is further lowered and regenerative braking control is executed in order to maintain the inter-vehicle distance Di at the target inter-vehicle distance value D_{trg}, until time t₄ when the vehicle 10 stops at time t₄. However, this deceleration operation of the vehicle 10 occurs after the preceding vehicle begins deceleration. Thus, even if the regenerative braking amount of the regenerative braking control is raised to a maximum, deceleration cannot be made in time only by the fuel injection cut and regenerative braking control. Accordingly, friction brakes are also operated, resulting in a sudden deceleration of the vehicle 10.

In contrast, in the follow-up control according to the present implementation as illustrated in the lower half of FIG. 7, while follow-up control based on vehicle speed is being executed, the follow-up is slightly eased at time t₁ when a far traffic light changes from a green light to a red light. Accompanying this, the engine output torque is lowered (a fuel injection cut is executed), and regenerative braking control is executed at a weak regenerative amount. As a result, the vehicle speed V of the vehicle 10 gently decreases.

When the preceding vehicle commences a braking operation at time t₃, the follow-up is further eased with the inter-vehicle distance Di between the vehicle 10 and the preceding vehicle being maintained not less than the inter-vehicle follow-up distance Dₜₕᵣₑ₁. Accompanying this, the engine output torque is further lowered, and the regenerative amount of the regenerative braking control is increased. As a result, the deceleration of the vehicle 10 moderately increases.

Thereafter, when the inter-vehicle distance D₁ between the vehicle 10 and the preceding vehicle becomes less than the inter-vehicle follow-up distance Dₜₕᵣₑ₁ at time t₅, the follow-up mode is switched from the follow-up mode based on vehicle speed to the follow-up mode based on inter-vehicle distance. Since the vehicle speed V of the vehicle 10 has already decreased at time t₅, the vehicle 10 subsequently decelerates gently by follow-up control based on inter-vehicle distance and then stops at time t₄.

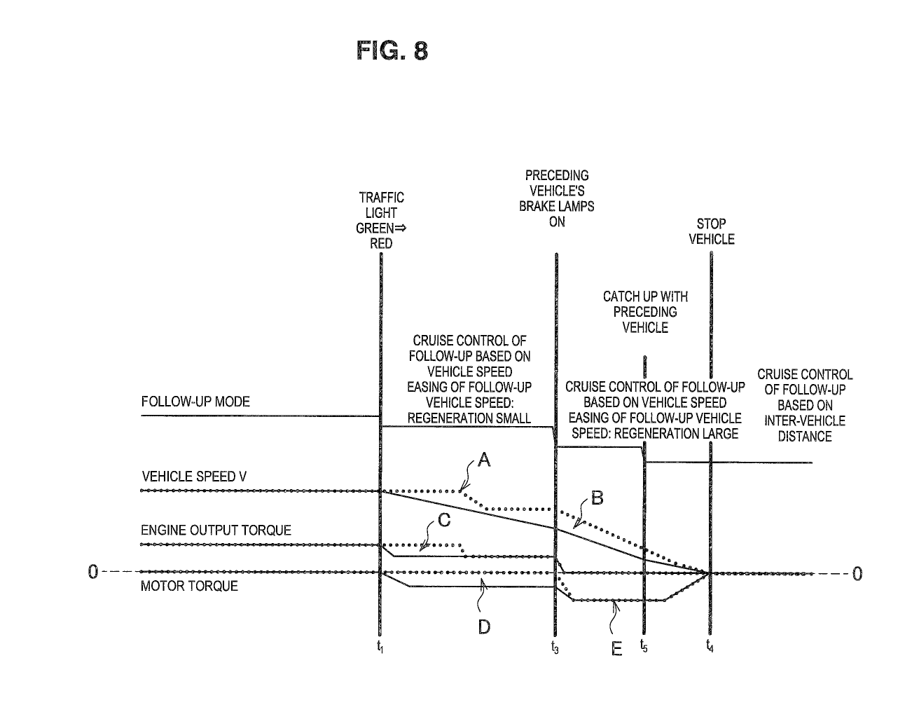

FIG. 8 illustrates the differences between the transitions of the respective vehicle speeds V, engine output torques, and motor torques of the conventional follow-up control and the follow-up control of the present implementation described above. The solid lines in FIG. 8 indicate the states of follow-up control according to the present implementation, while the dotted lines indicate the states of the conventional follow-up control. In the follow-up control of the present implementation, the follow-up in the follow-up control based on vehicle speed is gradually eased from an early stage, whereby the vehicle speed V begins to decrease at an early stage, and thereafter the vehicle 10 gently decelerates and then calmly stops (A region and B region). Accordingly, the drivability improves.

Also, in the follow-up control of the present implementation, the follow-up is eased at the time when a traffic light changes from a green light to a red light, whereby the engine output torque decreases at an early stage, and thus the fuel consumption decreases (C region). Furthermore, in the follow-up control of the present implementation, the follow-up is eased at an early stage, whereby regenerative braking control is started at an early stage, and so the entire regenerative amount increases (D region).

Furthermore, in the follow-up control of the present implementation, the vehicle speed V of the vehicle 10 has decreased from an early stage, whereby, after the preceding vehicle begins its braking operation, the vehicle speed V sufficiently falls due to the vehicle 10 increasing the regenerative amount of the regenerative braking control. Accordingly, it is not necessary to operate friction brakes. As a result, the energy that would have been lost as heat in the conventional follow-up control is recovered as electrical energy, and so the energy efficiency improves (E region).

### 4. Effects of Present Implementation

According to the present implementation described above, in the case of a far traffic light in the advancing direction of the vehicle 10 being a red light or a yellow light, or in the case of an obstacle existing far away, or in the case of a preceding vehicle performing a braking operation prior to the inter-vehicle distance Di becoming short, the follow-up in the follow-up control is eased in advance. For that reason, even during the follow-up control, the deceleration operation is started at an early stage, and so it is possible to stop the vehicle 10 without a sudden deceleration. Accordingly, it is possible to improve the drivability.

In addition, according to the present implementation, when follow-up in the follow-up control has been eased in advance, deceleration is realized by fuel injection cut control and regenerative braking control, whereby it is possible to improve fuel efficiency. In addition, since regenerative braking control is executed at an early stage, the regenerative amount increases, and it is also possible to inhibit energy loss to the maximum extent if it is possible to stop the vehicle without operating the friction brakes.

Although the preferred examples of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, the foregoing implementation has been described taking as an example a hybrid vehicle provided with the engine 55 and the motor/generator 74 as drive sources. Alternatively, even in a vehicle provided with only an engine as a drive source, it is possible to implement the present disclosure by means of fuel injection cut control and gear ratio control of an automatic transmission, instead of fuel injection cut control and regenerative braking control. In addition, it is possible to make suitable changes to the constitution of the hybrid vehicle illustrated in FIG. 1.

Also, the foregoing implementation determines a red light or yellow light as being a situation in which the preceding vehicle is predicted to decelerate. Alternatively, it may determine a flashing red light or yellow light as being a situation in which the preceding vehicle is predicted to decelerate.

Moreover, the forward monitoring unit of the foregoing implementation is composed of the SC-CU 110 that performs image processing of a stereo camera. Alternatively it may be configured to monitor information in the advancing direction of the vehicle 10 based on information obtained for example via inter-vehicle communication or an Intelligent Transport System (ITS).

1. A vehicle control device capable of executing follow-up control having a follow-up mode based on inter-vehicle distance in which cruise control is performed based on a target inter-vehicle distance and a follow-up mode based on vehicle speed in which cruise control is performed based on a target vehicle speed, the vehicle control device comprising:
a forward monitoring unit that monitors a piece of information in the advancing direction of a vehicle equipped with the vehicle control device; and
a follow-up control unit that eases the follow-up in the follow-up control and executes a deceleration operation of the vehicle when at least either one of a situation in which a preceding vehicle is predicted to decelerate and execution of a braking operation of the preceding vehicle is detected based on the piece of information in the advancing direction.

2. The vehicle control device according to claim 1, wherein, in the case of the vehicle being provided with an internal combustion engine as a drive source, the follow-up control unit executes the deceleration operation by restricting the amount of fuel injection to the internal combustion engine.

3. The vehicle control device according to claim 1, wherein, in the case of the vehicle being provided with an electric motor capable of executing regenerative braking control as a drive source, the follow-up control unit executes the deceleration operation by executing the regenerative braking control.

4. The vehicle control device according to claim 1, wherein the follow-up control unit executes the deceleration operation by increasing a gear ratio of a transmission interposed between a drive source and a drive shaft.

5. The vehicle control device according to claim 1, wherein the follow-up control unit executes the deceleration operation when the distance from the vehicle to the location of a cause of the situation in which the preceding vehicle is predicted to decelerate is equal to or greater than a predetermined value.

6. The vehicle control device according to claim 1, wherein the follow-up control unit, in the follow-up mode based on vehicle speed, releases or changes the current set value of the target vehicle speed when the situation in which the preceding vehicle is predicted to decelerate is not detected, and the execution of a braking operation of the preceding vehicle is detected.

7. The vehicle control device according to claim 1, wherein the follow-up control unit, in the follow-up mode based on vehicle speed, releases or changes the current set value of the target vehicle speed when the situation in which the preceding vehicle is predicted to decelerate is detected, irrespective of the execution of a braking operation of the preceding vehicle.

8. The vehicle control device according to claim 7, wherein, in the follow-up mode based on vehicle speed, the degree of easing of the follow-up in the case of a braking operation of the preceding vehicle being executed is greater than the degree of easing of the follow-up in the case of a braking operation of the preceding vehicle not being executed.

9. The vehicle control device according to claim 1, wherein, in the case of the vehicle being provided with an internal combustion engine and an electric motor capable of executing regenerative braking control as a drive source, and in the case of the situation in which the preceding vehicle is predicted to decelerate being detected and the execution of a braking operation of the preceding vehicle being detected in the follow-up mode based on vehicle speed, the follow-up control unit
restricts the amount of fuel injection to the internal combustion engine and executes regenerative braking control,
changes the set value of the target vehicle speed and determines a target deceleration based on the changed set value of the target vehicle speed and the actual vehicle speed of the vehicle, and
increases the regenerative amount of the regenerative braking control in the case of the target deceleration being predicted to be unachievable only by restriction of the amount of fuel injection.

10. The vehicle control device according to claim 1, wherein, in the case of the vehicle being provided with an internal combustion engine as a drive source, and in the case of the situation in which the preceding vehicle is predicted to decelerate being detected and the execution of a braking operation of the preceding vehicle being detected in the follow-up mode based on vehicle speed, the follow-up control unit
restricts the amount of fuel injection to the internal combustion engine,
changes the set value of the target vehicle speed and determines a target deceleration based on the changed set value of the target vehicle speed and the actual vehicle speed of the vehicle, and
increases the gear ratio of a transmission interposed between the drive source and a drive shaft in the case of the target deceleration being predicted to be unachievable only by restriction of the amount of fuel injection.

11. The vehicle control device according to claim 1, wherein the follow-up control unit in the follow-up mode based on vehicle speed eases the follow-up by changing the set value of the target vehicle speed to a value that is less than the current set value.

12. The vehicle control device according to claim 1, wherein, in the case of the situation in which the preceding vehicle is predicted to decelerate being detected and the execution of a braking operation not being detected in the follow-up mode based on inter-vehicle distance, the follow-up control unit releases or changes the set value of the target inter-vehicle distance.

13. The vehicle control device according to claim 1, wherein, in the case of the vehicle being provided with an internal combustion engine and an electric motor capable of executing regenerative braking control as a drive source, and in the case of the situation in which the preceding vehicle is predicted to decelerate being detected and the execution of a braking operation not being detected in the follow-up mode based on inter-vehicle distance, the follow-up control unit
restricts the amount of fuel injection to the internal combustion engine and executes the regenerative braking control, and
increases the regenerative amount of the regenerative braking control in the case of the inter-vehicle distance between the vehicle and the preceding vehicle not widening.

14. The vehicle control device according to claim 1, wherein, in the case of the vehicle being provided with an internal combustion engine as a drive source, and in the case of the situation in which the preceding vehicle is predicted to decelerate being detected and the execution of a braking operation not being detected in the follow-up mode based on inter-vehicle distance, the follow-up control unit
restricts the amount of fuel injection to the internal combustion engine, and
increases the gear ratio of a transmission interposed between the drive source and a drive shaft in the case of the inter-vehicle distance between the vehicle and the preceding vehicle not widening.

15. The vehicle control device according to claim 1, wherein the follow-up control unit in the follow-up mode based on inter-vehicle distance eases the follow-up by changing the set value of the target inter-vehicle distance to a value that is greater than the current set value.

16. The vehicle control device according to claim 1, wherein the forward monitoring unit monitors the piece of information in the advancing direction based on a piece of imaging information provided by a camera.

17. The vehicle control device according to claim 1, wherein the forward monitoring unit identifies a traffic light ahead and an illuminated color of the traffic light.

18. The vehicle control device according to claim 1, wherein the forward monitoring unit identifies an obstacle ahead.

19. The vehicle control device according to claim 16, wherein the forward monitoring unit identifies the illumination of a brake lamp of the preceding vehicle based on the piece of imaging information provided by the camera.

20. A vehicle control method that executes follow-up control by a follow-up mode based on inter-vehicle distance in which cruise control is performed based on a target inter-vehicle distance and a follow-up mode based on vehicle speed in which cruise control is performed based on a target vehicle speed, the vehicle control method comprising:
monitoring a piece of information in the advancing direction of a vehicle to which the vehicle control method is applied; and
easing the follow-up in the follow-up control and executing a deceleration operation of the vehicle when at least one of a situation in which a preceding vehicle is predicted to decelerate and execution of a braking operation of the preceding vehicle is detected based on the piece of information in the advancing direction.
